(19) United States
(12) Patent Application Publication
(10) Pub. No.: US 2007/0240285 A1
(43) Pub. Date: Oct. 18, 2007

(54) CARD CONSTRUCTION CLIPS

(76) Inventors: Yuval Caspi, Granada Hills, CA (US); Brady Aaron Lang, Los Angeles, CA (US)

Correspondence Address: IRELL & MANELLA LLP, 1800 AVENUE OF THE STARS, SUITE 900, LOS ANGELES, CA, 90067, US

(21) Appl. No.: 11/734,731

(22) Filed: Apr. 12, 2007

Related U.S. Application Data
(60) Provisional application No. 60/792,256, filed on Apr. 13, 2006.

(51) Int. Cl. B42F 1/00

(52) U.S. Cl. 24/67.11

(57) ABSTRACT

A set of card construction clips for combining cards to form a structure may include inline clips, each including a pair of clip jaws, each clip jaw mounted on opposite sides of a central support section along an axis. Angle clips may have a pair of clip jaws mounted on different sides of the central support section and have an included angle of less than 180° between them. Clips more than two clip jaws mounted to the central support section may also be provided. Each clip jaw may include a pair of opposing jaws with teeth in a central slot which may terminate in a stress relief opening having a registration surface that control card insertion depth. Clips may have an included angle on the order of about 135°, 45° or 90° between the clip jaws. Clips may be provided with three or four clip jaws.

This application claims the benefit of the priority of the filing of U.S. Provisional Application Ser. No. 60/792,256, filed Apr. 13, 2006.

### BACKGROUND OF THE INVENTION

1. Field of the Invention

This invention is related to clips for use with cards, such as postcards, playing cards, business cards and the like and in particular to a set of card construction clips suitable for building structures with the cards and displaying them.

2. Description of the Prior Art

The phrase “house of cards” has come to colloquially mean a fragile construction that may easily crumble if one element is moved or otherwise proves unsatisfactory. What is needed are techniques for constructing more robust structures from cards.

### BRIEF DESCRIPTION OF THE DRAWINGS

FIG. 1 is a top view of an inline card construction clip, i.e. one having an included angle of about 180°.

FIG. 2 is a top view of a wide angle card construction clip having an included angle of about 135°.

FIG. 3 is a top view of a narrow angle card construction clip having an included angle of about 45°.

FIG. 4 is a top view of a four way card construction clip, in the form of a cross, i.e. having an included angle of about 90° between each of four arms.

FIG. 5 is a top view of a three way card construction clip in the form of a “T”, i.e. having an included angle of about 90° between each of three arms.

FIG. 6 is a top view of a right angle card construction clip having an included angle of about 90° between two arms.

FIG. 7 is a side view of a portion of a card structure using the card construction clips of FIGS. 1-5.

### SUMMARY OF THE INVENTION

A set of card construction clips for combining cards to form a structure may include a first plurality of inline clips, each incline clip including a pair of clip jaws, each clip jaw mounted on opposite sides of a central support section along an axis. The set may also include a second plurality of angle clips each angle clip including a pair of clip jaws mounted on different sides of the central support section and having an included angle of less than 180° between the pair clip jaws. A third plurality of clips each including more than two clip jaws mounted to the central support section may also be provided.

Each clip jaw may include a pair of opposing jaws, each having a plurality of raised contact points, or teeth, in a central slot. The central slot may terminate in a registration surface that controls the depth to which a card may be inserted between each pair of opposing jaws. The registration surface may be part of a stress relief opening between at the end of the slot between the opposing jaws.

The second plurality of angle clips may include wide angle clips having an included angle on the order of about 135° between the clip jaws, narrow angle clips having an included angle on the order of about 45° between the clip jaws, and/or right angle clips having an included angle on the order of about 90° between the clip jaws. The third plurality of clips may include four clips having an angle on the order of about 90° between each of clip jaws and/or three clip jaws forming a “T” shape in which a clip jaw is mounted on opposite sides of a central clip jaw at an angle on the order of about 90°.

### DETAILED DISCLOSURE OF THE PREFERRED EMBODIMENT(S)

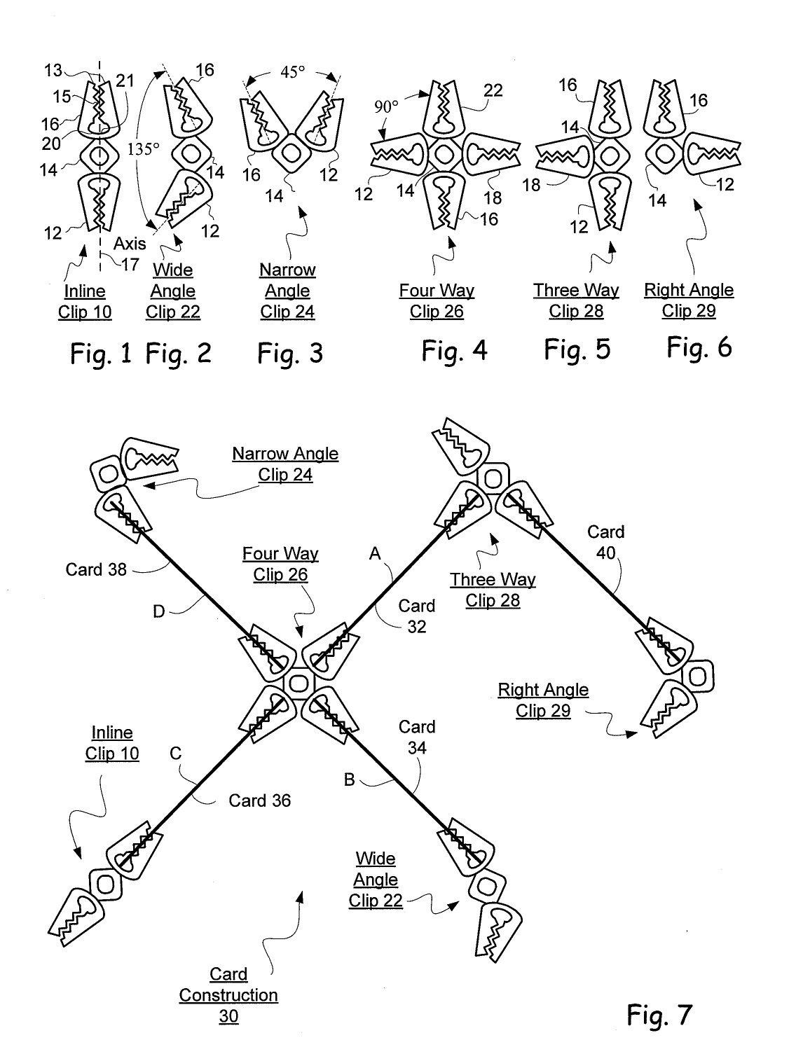

Referring now to FIG. 1, inline card construction clip 10 is shown including lower clip jaws 12, central support section 14 and upper clip jaws 16 mounted in the plane of clips jaws 12 along central axis 17, that is, each clip jaw being at an angle of 180° from the other clip jaw. Each clip jaw 12, 16 includes a pair of opposing jaws 13 forming an opening or slot there between each jaw including multiple raised contact points, such as teeth 15, positioned on opposite sides of axis 17 to resiliently grasp a card inserted in the jaw slot. Any suitable plastic or similar material which has the appropriate strength and resilience can be used for the clip jaws such as a polypropylene copolymer, high impact polystyrene, polyoxyrnethylene or the like. The shape of internal jaw slot should allow the teeth on each opposing jaw to resiliently grasp a suitable card between them. The card should be inserted easily and then forced inwardly to be held in place by the multiple teeth in each side of the opposing jaw. Appropriate stress relief, such as opening 20 at the bottom of the clip jaws, may be provided in the area in which the pair of opposing jaws 13 are mounted together for resilient motion in the manner of a hinge to accept or allow removal of a cart. Opening 20 may be at the closed end of opposing jaws 13 and include registration surface 21 along the axis of the slot, such as axis 17 in inline clip 10. Registration surface 21 permits each card to be inserted by approximately the same distance into each clip jaw so that larger, more complex and structurally sound card constructions can be made.

Referring now to FIG. 2, wide angle construction clip 22 is similar to inline construction clip 10 except that upper and lower clip jaws 12, 16 are mounted to central support section 14 so that cards inserted in the clip jaws would have an included angle of about 135° as shown.

Referring now to FIG. 3, narrow angle construction clip 24 is similar to inline construction clip 22 except that upper and lower clip jaws 12, 16 are mounted to central support section 14 so that cards inserted in the clip jaws would have an included angle of about 45° as shown.

Referring now to FIG. 4, four way or cross construction clip 26 is similar to inline construction clip 10 except that each of the four clip jaws 12, 16, 18 and 22 are mounted to central support section 14 at an angle of about 90° as shown.

Referring now to FIG. 5, three way or “T” shaped construction clip 28 is similar to inline construction clip 10 except that a third clip jaw 18 is mounted to central support section 14 at an angle of about 90° from each of the inline clip jaws 12, 16 as shown. That is, 1 three clip jaws 12, 16 and 18 forming “T” shape because clip jaws 12 and 16 are mounted on opposite sides of central clip jaw 18 at an angle on the order of about 90°.

Referring now to FIG. 6, right angle construction clip 29 is similar to inline construction clip 10 except that clip jaws 12, 16 are mounted to central support section 14 at an angle of 90° from each other.

Referring now to FIG. 7, in order to simply illustrate the basic technique for construction using construction clips 10, 22, 24, 26, 28 and 29, a partial, simple card construction structure 30 is made by inserting one side of card 32, which may be a playing card, a post card, a business card or a photograph or the like, into one of the clip jaws of four way or cross clip 26 and inserting the other side of card 32 into one of the clip jaws of three way or “T” clip 28. It should be noted the card 32 may be positioned between clips length way or width wise. Similarly, card 34 may be inserted into one of the clip jaws of narrow angle clip 22 and of cross clip 26. Cards 36 and 38 may also be inserted into one of the clip jaws of cross clip 22, and of inline clip 10, as well as into one of the clip jaws of narrow angle clip 24, respectively. Similarly, one side of card 40 may be inserted in one of the unused clip jaws of “T” clip 28 and the other end may be inserted in one of the jaws of right angle construction clip 29. Other cards and other construction clips may be added to form a more complex structure. Card construction structure 30 as shown is in a single plane, but multiple level construction can easily be accomplished by, for example, adding additional inline clips 10 at points A, B, C, D at cards 32, 34, 36 and 38 where indicated.

An almost unlimited number of arrangements of construction clips and cards may be assembled to form houses of cards or other structures for both the artistry of forming the structures as well as forming convenient display racks for the cards, for example, to display postcards or photographs. The construction clips illustrated in FIGS. 1-5 are good examples of useful construction clips but other angles and other configurations may be used.

A set of card construction clips may include different pluralities of different clips, for example, a small number of four way and three clips 26, 28, a larger number of wide angle and narrow angle clips 22, 24, a still larger number of right angle clips 29 plus a much larger number of inline clips 10 to that a single large card construction structure may be produced.

We claim as our invention:

1. A set of card construction clips for combining cards to form a structure, comprising:
a first plurality of inline clips, each incline clip including a pair of clip jaws, each clip jaw mounted on opposite sides of a central support section along an axis; and
a second plurality of angle clips each angle clip including a pair of clip jaws mounted on different sides of the central support section and having an included angle of less than 180° between the pair clip jaws; and
a third plurality of clips each including more than two clip jaws mounted to the central support section,
wherein each clip jaw includes a pair of opposing jaws, each opposing jaw including a plurality of raised contact points in a central slot.

2. The set of card construction clips as claimed in claim 1 wherein the central slot terminates in a registration surface that controls the depth to which a card may be inserted between each pair of opposing jaws.

3. The set of card construction clips as claimed in claim 2 wherein the registration surface is part of a stress relief opening near the end of the slot between the opposing jaws.

4. The set of card construction clips as claimed in claim 1 wherein the second plurality of angle clips includes wide angle clips having an included angle on the order of about 135° between the clip jaws.

5. The set of card construction clips as claimed in claim 1 wherein the second plurality of angle clips includes narrow angle clips having an included angle on the order of about 45° between the clip jaws.

6. The set of card construction clips as claimed in claim 1 wherein the second plurality of angle clips includes right angle clips having an included angle on the order of about 90° between the clip jaws.

7. The set of card construction clips as claimed in claim 1 wherein the third plurality of clips includes four clips having an angle on the order of about 90° between each of clip jaws.

8. The set of card construction clips as claimed in claim 1 wherein the third plurality of clips includes three clip jaws forming a “T” shape in which a clip jaw is mounted on opposite sides of a central clip jaw at an angle on the order of about 90°.
